(19) United States
(12) Patent Application Publication
(10) Pub. No.: US 2026/0001247 A1
(43) Pub. Date: Jan. 1, 2026

(54) SAFETY CUTTING DEVICE AND METHOD

(71) Applicants: Xiangyang Zhang, North Potomac, MD (US); Zuyu Zhang, North Potomac, MD (US); Yixuan Li, North Potomac, MD (US)

(72) Inventors: Xiangyang Zhang, North Potomac, MD (US); Zuyu Zhang, North Potomac, MD (US); Yixuan Li, North Potomac, MD (US)

(21) Appl. No.: 19/031,934

(22) Filed: Jan. 18, 2025

Related U.S. Application Data
(60) Provisional application No. 63/666,168, filed on Jun. 30, 2024.

(51) Int. Cl. B26B 21/40; B26B 21/08

(52) U.S. Cl. CPC B26B 21/4018; B26B 21/08; B26B 21/4075

(57) ABSTRACT

A cutting device and a method are designed to facilitate precise cutting and prevent a user from cutting fingers and hands. The cutting device includes a body and a lid. The body has a mounting mechanism, to which a razor blade is removably attached. The lid is pivotably coupled to the body by a spring. Moreover, the lid partially covers the razor blade so that at least one cutting edge of the razor blade is exposed. Thus, the cutting device safeguards the razor blade and protects the user's fingers, hands, and other body parts while allowing at least one cutting edge of the razor blade for cutting operations.

### CROSS-REFERENCE TO RELATED APPLICATIONS

The present application claims the benefit of U.S. Provisional Application Ser. No. 63/666,168 filed on Jun. 30, 2024.

### TECHNICAL FIELD

The present disclosure relates to a cutting device, and more particularly to a hand-held safety cutting device using a razor blade and a method for safe cutting while holding the cutting device.

### BACKGROUND INFORMATION

Razor blades, such as single edged razor blades and double edged razor blades, of many hand-held cutting devices are used in scientific and medical applications to make precise cuts on tissues, plant leaves and the like. However, they are inadequate due to lack of flexibility, sharpness, and safety. For example, the single edged razor blade is safe hand-held for tissue cutting but is not flexible and does not have an ultra-thin sharp cutting edge. Some finger held razor blades are designed for precise and flexible finger-controlled cuts such as cutting plant leaf, seed, flower or root to small pieces for cell nucleus extraction, or cutting animal tissue and marine organisms for single cell suspension. Often, these cutting devices cause users to cut their fingers, etc., during cutting activities. There are also risks of getting cut when changing the razor blades, making adjustments and maintenance to the cutting devices. Most existing hand-held cutting devices either do not provide precise cutting, or do not provide covering and/or side protections to double edged razor blades on the cutting devices. For example, if a user slips on the cutting surface, an uncovered or unprotected edge of a double edged razor blade may incur cuts to the user. If the user exerts excessive force trying to make a cut and the razor blade slips or tears, the user may get finger cuts, or even lacerations. Thus, an improved or innovative design of the hand-held cutting device is critical to protect the user from any cuts while providing efficiently precise cutting operations.

The present disclosure provides an innovative hand-held cutting device and method to improve the safety of a user during precise cutting activities. The cutting device provides tight enclosure to the razor blade so that only the necessary cutting edge of the razor blade is exposed for cutting. The rest of the sharp edges are covered inside the cutting device. Moreover, the cutting device incorporates a unique design that includes surface indentations to allow the user to particularly and more efficiently transfer the finger force from the cutting device to the cutting edge. Thus, the cutting device not only improves the precise cutting but also substantially mediates the cutting hazards.

### SUMMARY

The terms, e.g., implementation, configuration, aspect, example, and option, are intended to refer broadly to the subject matter of this disclosure and the claims below. Statements containing these terms should be understood not to limit the subject matter described herein or to limit the meaning or scope of the claims below. Implementations of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

According to certain aspects of the present disclosure, a cutting device includes a body, a lid, and a spring. The body has a mounting mechanism, to which a razor blade is removably attached. The lid is pivotably coupled to the body. Moreover, the lid partially covers the razor blade so that at least one cutting edge of the razor blade is exposed. Further, the spring is coupled between the body and the lid.

According to one aspect of the present disclosure, the cutting device includes an indentation. The indentation is positioned on an exterior surface of the body.

According to a configuration of the above implementation, the mounting mechanism includes one or more studs.

According to one aspect of the above configuration, the one or more studs have a shape of a cross.

According to another configuration of the above implementation, the one or more studs include a plurality of studs. The plurality of studs distributes across a longitudinal side of the body. Moreover, each of the plurality of studs is configured to align with a corresponding one of a plurality of mounting holes of the razor blade.

According to another aspect of the present disclosure, the lid includes one or more lid indentations. The one or more lid indentations are positioned on an interior lid surface of the lid.

According to yet another aspect of the present disclosure, each of the one or more studs is configured to align with a corresponding one of the one or more lid indentations and snugly fit therein.

According to a configuration of the above implementation, the body further includes a front, a back, a top, and a bottom. The top is positioned on the body opposite the bottom. The top has a front portion and a back portion. The front portion is positioned adjacent to the front. The mounting mechanism is positioned on the front portion of the top.

According to another configuration of the above implementation, the back portion of the top is positioned adjacent the back of the body. The lid covers the front portion of the top, and an exterior top surface of the back portion is flush with an exterior lid surface.

According to yet another configuration of the above implementation, the cutting device includes a first indentation and a second indentation. The first indentation is positioned across the exterior top surface of the back portion and the exterior lid surface. The second indentation is positioned on an exterior bottom surface of the bottom.

According to a further configuration of the above implementation, the front portion has one or more curved sides.

According to another aspect of the present disclosure, the lid has a lid front. The lid front is aligned with the front of the body to form a concave portion. Moreover, the at least one cutting edge of the razor blade extends across the concave portion.

According to a configuration of the above implementation, the lid includes one or more tabs. The one or more tabs are externally positioned on the lid adjacent to the lid front.

According to another configuration of the above implementation, the body further includes a first side and a second side. The second side is positioned opposite the first side. The back portion and the bottom define a cavity that is positioned adjacent to the first side. Moreover, the cavity has a first interior surface and a second interior surface.

According to another aspect of the present disclosure, the cutting device includes a spring. The spring is distally coupled to the lid and attached to the first interior surface of the cavity.

According to a configuration of the above implementation, the lid has a first arm and a second arm. The first arm is coupled to the second interior surface of the cavity. Moreover, the second arm is coupled to the second side of the body.

According to yet another aspect of the present disclosure, the cutting device includes a razor blade, a body, a lid, a spring, and one or more indentations. The razor blade has at least one cutting edge. The body has a mounting mechanism, to which the razor blade is removably attached. The lid is pivotably coupled to the body. Additionally, the lid partially covers the razor blade and the at least one cutting edge of the razor blade is exposed. The spring is coupled between the body and the lid. Further, the one or more indentations are positioned on an exterior surface of the body to allow a user to efficiently and firmly hold the cutting device during precise cutting activities.

According to a further aspect of the present disclosure, a method of providing a cutting device includes opening a lid of the cutting device. The lid is pivotably coupled to a body of the cutting device, and the cutting device has a mounting mechanism positioned on the body. Additionally, the method includes mounting a razor blade on the mounting mechanism. The method further includes closing the lid so that at least one cutting edge of the razor blade is exposed for cutting operations.

According to a configuration of the above implementation, the method includes securing the lid on the body. The mounting mechanism has one or more studs. The lid has one or more lid indentations. Each of the one or more studs snugly fits in a corresponding one of the one or more lid indentations.

According to another configuration of the above implementation, the method includes holding the cutting device via one or more indentations exteriorly positioned on the body or the lid.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative implementations and modes of the present disclosure, taken in connection with the accompanying drawings and the appended claims. Additional aspects of the disclosure will be apparent to those of ordinary skill in the art in view of the detailed description of various implementations, which is made with reference to the drawings, a brief description of which is provided below.

### BRIEF DESCRIPTION OF THE DRAWINGS

Objects, features and advantages disclosed herein will be apparent from the following detailed description, as illustrated in the accompanying drawings in which reference characters and descriptions refer to the same parts throughout the different views. The drawings are not necessarily to scale, emphasis instead being placed upon illustrating the principles disclosed herein. For purposes of clarity, not every component may be labeled in every drawing.

FIG. 1 is an isometric perspective view of a cutting device with a lid open and a razor blade installed on a body, consistent with certain aspects of the present disclosure.

FIG. 2 is an isometric perspective view of the cutting device with the lid closed and the razor blade installed on the body, consistent with certain aspects of the present disclosure.

FIG. 3 is a perspective view of the cutting device with the lid closed and the razor blade installed on the body that is held by fingers of a user's hand, consistent with certain aspects of the present disclosure.

FIG. 4 is an isometric perspective view of a cutting device with a lid open, consistent with certain aspects of the present disclosure.

FIG. 5 is an isometric perspective view of the cutting device with the lid closed, consistent with certain aspects of the present disclosure.

FIG. 6 is a bottom perspective view of the cutting device with the lid closed, consistent with certain aspects of the present disclosure.

FIG. 7 is an isometric perspective view of a cutting device with a lid open and without a spring, consistent with certain aspects of the present disclosure.

FIG. 8 is an isometric perspective view of the cutting device with the lid closed and without a spring, consistent with certain aspects of the present disclosure.

FIG. 9 is a bottom perspective view of the cutting device with the lid closed and without a spring, consistent with certain aspects of the present disclosure.

FIG. 10 is a flowchart diagram showing a method of providing safety cutting, consistent with certain aspects of the present disclosure.

### DETAILED DESCRIPTION

A cutting device is designed to facilitate precise cutting and prevent a user from cuts of fingers and hands. Specifically, the cutting device includes a body, a lid, and a spring. The body has a mounting mechanism, to which a razor blade is removably attached. The lid is pivotably coupled to the body by a spring that is positioned between the body and the lid. Moreover, the lid partially covers the razor blade so that at least one cutting edge of the razor blade is exposed. Thus, the cutting device safeguards the razor blade to protect the user's fingers, hands, and other body parts against injuries while allowing at least one cutting edge of the razor blade for cutting operations.

Moreover, a method of providing a user precise cutting while protecting the user's fingers and hands using a cutting device. The method includes opening a lid of the cutting device. The lid is pivotably coupled to a body of the cutting device by a spring that is coupled between the body and the lid. Additionally, the cutting device has a mounting mechanism positioned on the body. The open lid allows the user to access the mounting mechanism. The method then mounts a razor blade on the mounting mechanism. Further, the method includes closing the lid with at least one cutting edge of the razor blade exposed for cutting operations.

Various implementations are described with reference to the attached figures, where like reference numerals are used through the figures to designate similar or equivalent elements. Each reference numeral identifies the figure in which the reference numeral first appears based on the first digit (for three-digit reference numerals) or the first two digits (for four-digit reference numerals) corresponding to the figure numeral of the figure. The figures are necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various implementations disclosed herein are not necessarily limited by the illustrated ordering of acts or events, as some acts may occur in different orders and/or concurrently with other acts or events. Further, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or elements(s); or as otherwise described herein.

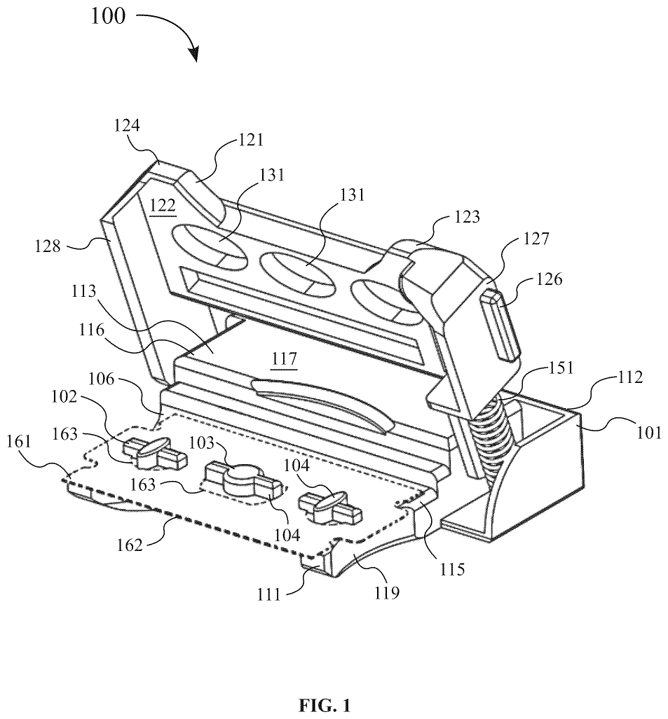

FIG. 1 illustrates a cutting device 100 with a lid 121 opened and a razor blade 161 installed on a body 101. Specifically, the cutting device 100 includes the body 101, the lid 121, the razor blade 161, and a spring 151. The body 101 has a mounting mechanism 102. The mounting mechanism 102 is fully covered by the lid 121 when the lid 121 is closed. The razor blade 161 is removably attached to the mounting mechanism 102. The lid 121 is pivotably coupled to the body 101. When the lid 121 is open, the mounting mechanism 102 allows the razor blade 161 to be installed on the mounting mechanism 102. When the lid 121 is closed, the lid 121 partially covers the razor blade 161 and allows at least one cutting edge 162 of the razor blade 161 to be exposed for cutting. Moreover, the spring 151 is coupled between the body 101 and the lid 121 so as to snap the lid 121 shut onto the body 101.

As shown in FIG. 1, the mounting mechanism 102 includes one or more studs 103 that are used to receive the razor blade 161. In some implementations, the one or more studs 103 are designed to have a shape of a cross. For example, the one or more studs 103 include a plurality of studs 104. The plurality of studs 104 distributes across a longitudinal side 106 of the body 101, and each of the plurality of studs 104 is designed to align with a corresponding one of a plurality of mounting holes 163 of the razor blade 161.

As shown in FIG. 1, the lid 121 includes one or more lid indentations 131 that are positioned on an interior lid surface 122 of the lid 121. Moreover, each of the one or more studs 103 is designed to align with a corresponding one of the one or more lid indentations 131 so that each of the one or more studs 103 snugly fits therein (e.g., in the corresponding one of the one or more lid indentations 131). Thus, when the lid 121 snaps onto the body 101, the one or more lid indentations 131 covers the one or more studs 103 so that the lid 121 tightly holds the razor blade 161 on the body 101 by the spring 151.

As shown in FIG. 1, the body 101 further includes a front 111, a back 112, and a top 113. The top 113 has a front portion 115 and a back portion 116. The front portion 115 is positioned adjacent to the front 111. Moreover, the mounting mechanism 102 is positioned on the front portion 115 of the top 113. The front portion 115 provides a support surface for the razor blade 161 to be positioned on. The front portion 115 allows the razor blade 161 to be mounted onto the mounting mechanism 102. Additionally, the front portion 115 has one or more curved sides 119. In some implementations, the one or more curved sides 119 are positioned on each lateral side of the front portion 115. Further, with the spring 151, the lid 121 tightly snaps on the body 101 so as to hold the razor blade 161 in place during cutting operations.

The back portion 116 of the top 113 is positioned adjacent the back 112 of the body 101, as shown in FIG. 1. The top 113 has an exterior top surface 117 that is on top of the back portion 116. When the lid 121 is closed onto the body 101, the lid 121 covers the front portion 115 of the top 113.

As shown in FIG. 1, the lid 121 has a lid front 124 and one or more tabs 126. The one or more tabs 126 is externally positioned on the lid 121 adjacent to the lid front 124. Moreover, the lid 121 has a first arm 127 and a second arm 128. The one or more tabs 126 are positioned on each of the first arm 127 and the second arm 128. Further, in some implementations, the spring 151 is positioned adjacent to the first arm 127.

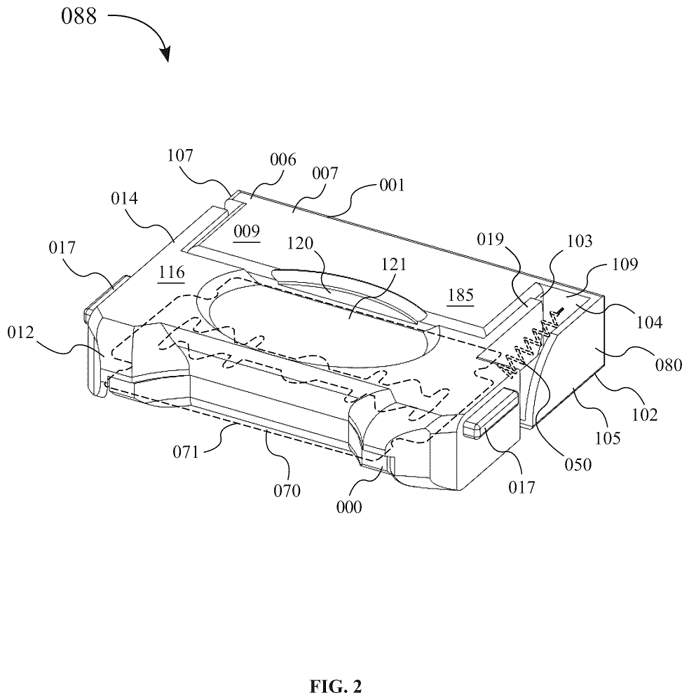

FIG. 2 illustrates the cutting device 100 with the lid 121 closed and the razor blade 161 installed on the body 101 of the cutting device 100. The at least one cutting edge 162 of the razor blade is exposed and extends out of the front 111 of the body 101 and the lid front 124 of the lid 121. The one or more tabs 126 are positioned on each of the first arm 127 and the second arm 128 of the lid 121. Additionally, the one or more tabs 126 are positioned adjacent to the lid front 124. The body 101 further has an exterior surface 205 and a bottom 214. The exterior surface 205 includes the exterior top surface 117 of the top 113. The exterior top surface 117 is positioned on the back portion 116 adjacent to the back 112 of the body 101. Moreover, the lid 121 has an exterior lid surface 223. When the lid 121 is closed onto the body 101, the exterior top surface 117 of the back portion 116 is flush with an exterior lid surface 223.

As shown in FIG. 2, the cutting device 100 further includes one or more indentation 241. The one or more indentation 241 are positioned on the exterior surface 205 of the body 101. The one or more indentations 241 are designed to allow a user to finger hold the cutting device 100 to facilitate precision cutting for scientific purposes. Moreover, the one or more indentation 241 include a first indentation 242. The first indentation 242 is positioned across the exterior top surface 117 of the back portion 116 and the exterior lid surface 223.

As shown in FIG. 2, the body 101 of the cutting device 100 further includes a bottom 214, a first side 215 and a second side 216. The second side 216 is positioned opposite the first side 215. The back portion 116 and the bottom 214 define a cavity 217. Specifically, the cavity 217 is positioned adjacent to the first side 215. Moreover, the cavity 217 has a first interior surface 218 and a second interior surface 219. The first interior surface 218 is positioned adjacent to the back 112. The second interior surface 219 is positioned adjacent to the first arm 127 of the lid 121. The first arm 127 of the lid 121 is coupled to the second interior surface 219 and the second arm 128 of the lid 121 is coupled to the second side 216 of the body 101. Further, the spring 151 is distally coupled to the lid 121 and distally attached to the first interior surface 218 of the cavity 217, as shown in FIG. 2.

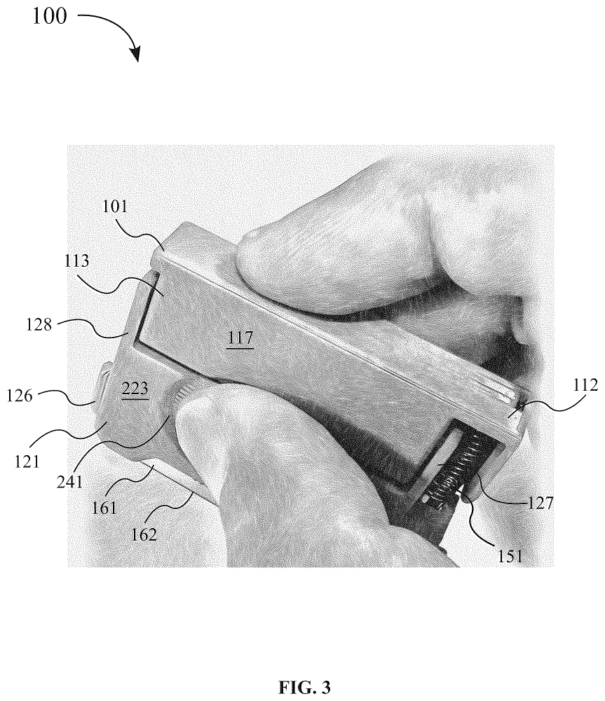

FIG. 3 illustrates the cutting device 100 being held by fingers of the user ready for precision cutting. The user uses three fingers to hold the cutting device 100 including: (i) a thumb positioned in the one or more indentations 241, (ii) a forefinger pressing the back 112 of the body 101, and (iii) a middle finger positioned on the opposite side of the exterior top surface 117. The lid 121 is coupled to the spring 151 adjacent to the first arm 127 of the lid 121. The spring 151 is also coupled to the body 101. Thus, the spring 151 exerts a spring force to pull the lid 121 to tightly close the razor blade 161 on the body 101 with the at least one cutting edge 162 of the razor blade 161 exposed for cutting operations. The exterior lid surface 223 is flush with exterior top surface 117 of the top 113, and the one or more indentation 241 is positioned across both the exterior lid surface 223 and the exterior top surface 117. The one or more tabs 126 positioned on the first arm 127 and the second arm 128 help the user open the lid 121 when needed for, e.g., changing the razor blade 161.

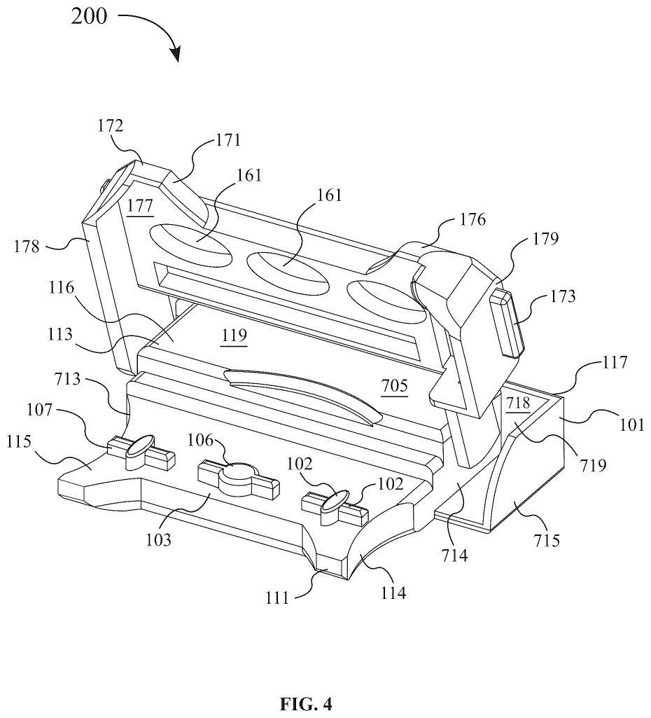

FIG. 4 illustrates a cutting device 400 that is substantially the same as the cutting device 100 as shown in FIG. 1 and FIG. 2. The cutting device 400 differs from the cutting device 100 in that the cutting device 400 does not include the spring 151 installed in the cavity 217. Additionally, cutting device 400 does not have a razor blade installed, but may be installed onto the mounting mechanism 102 by the user as desired.

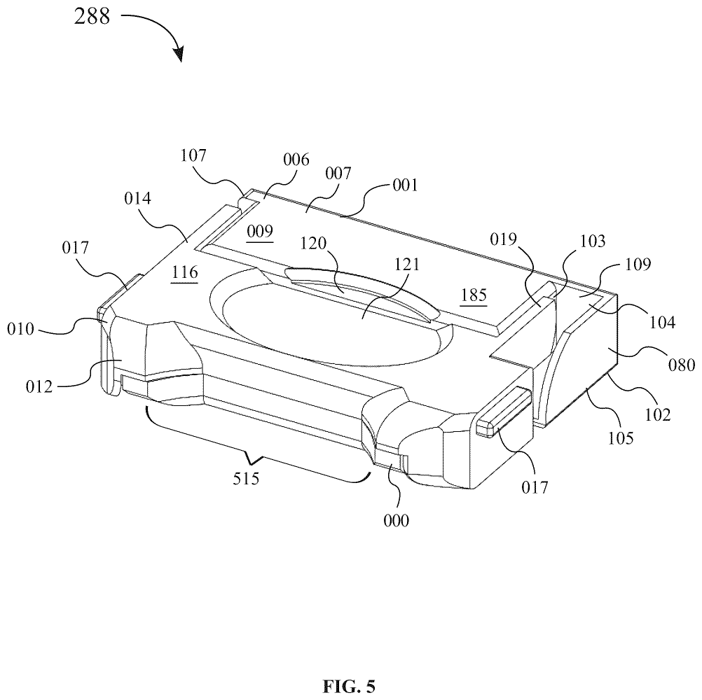

FIG. 5 illustrates the cutting device 400 with the lid 121 closed on the body 101. Specifically, the lid 121 has the lid front 124 that is aligned with the front 111 of the body 101 to form a concave portion 525. The concave portion 525 is designed to allow the at least one cutting edge 162 of the razor blade 161 extending across the concave portion 525, as shown in FIG. 2 to FIG. 3. Thus, the remaining edges including at least one other cutting edge of the razor blade 161 are concealed and tightly enclosed inside the lid 121 to protect the user from cuts during cutting operations.

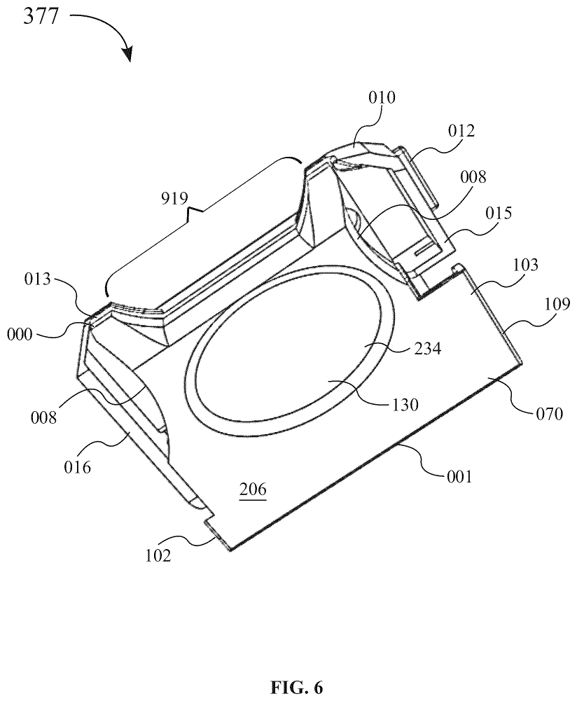

FIG. 6 illustrates the cutting device 400 with the one or more indentations 241 via a bottom perspective view. Specifically, the one or more indentations 241 include a second indentation 643 that is positioned on the bottom 214 of the body 101. Specifically, the bottom 214 has an exterior bottom surface 618. The second indentation 643 is positioned on the exterior bottom surface 618. With the lid 121 closed on the body 101, the lid front 124 is aligned with the front 111 of the body 101, thus defining the concave portion 525 where the at least one cutting edge 162 of the razor blade 161 extends through. The first side 215 and the second side 216 of the body 101 each have the one or more curved sides 119. The first arm 127 of the lid 121 is positioned adjacent to the first side 215 of the body 101, while the second arm 128 is positioned adjacent to the second side 216, as shown in FIG. 6.

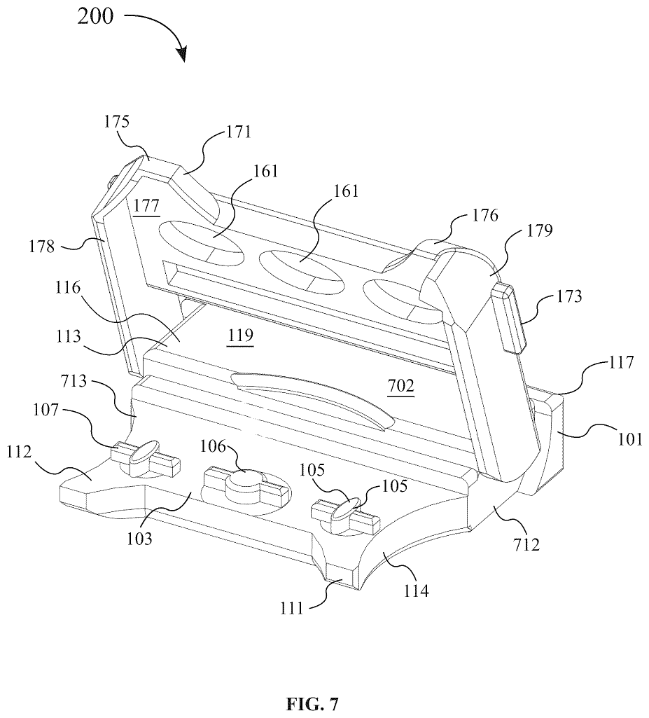

FIG. 7 illustrates a cutting device 500 that is similar to the cutting device 100 shown in FIG. 1 and the cutting device 400 shown in FIG. 4. The cutting device 500 differs from the cutting devices 100 and 400 in that the cutting device 500 does not include the spring 151 installed in the device 500. Additionally, the cutting device 500 does not have the cavity 217. Furthermore, the cutting device 500 does not have a razor blade installed, but may be installed onto the mounting mechanism 102 by the user.

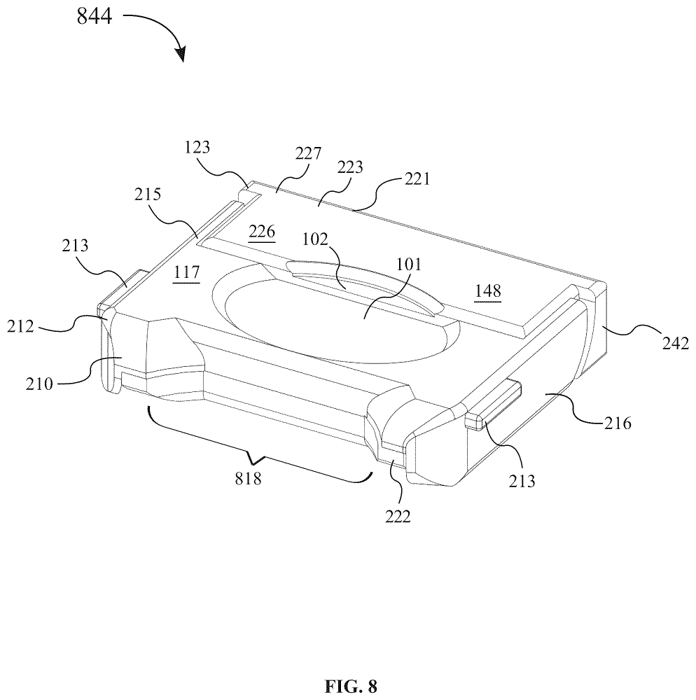

FIG. 8 illustrates the cutting device 500 with the lid 121 closed on the body 101. Specifically, the lid 121 has the lid front 124 that is aligned with the front 111 of the body 101 to form a concave portion 525. The concave portion 525 is designed to allow the at least one cutting edge 162 of the razor blade 161 extending across the concave portion 525, as shown in FIG. 2 to FIG. 3. Thus, the remaining edges including at least one other cutting edge of the razor blade 161 are concealed and tightly enclosed inside the lid 121 to protect the user from cuts during cutting operations.

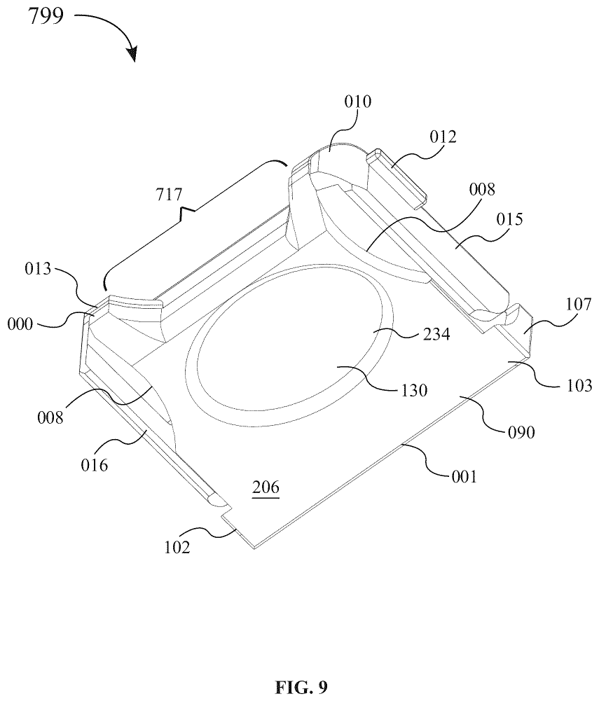

FIG. 9 illustrates the cutting device 900 with the one or more indentations 241 via a bottom perspective view. Specifically, the one or more indentations 241 include a second indentation 643 that is positioned on the bottom 214 of the body 101. Specifically, the bottom 214 has an exterior bottom surface 618. The second indentation 643 is positioned on the exterior bottom surface 618. With the lid 121 closed on the body 101, the lid front 124 is aligned with the front 111 of the body 101, thus defining the concave portion 525 where the at least one cutting edge 162 of the razor blade 161 extends through. The first side 215 and the second side 216 of the body 101 each have the one or more curved sides 119. The first arm 127 of the lid 121 is positioned adjacent to the first side 215 of the body 101, while the second arm 128 is positioned adjacent to the second side 216, as shown in FIG. 6.

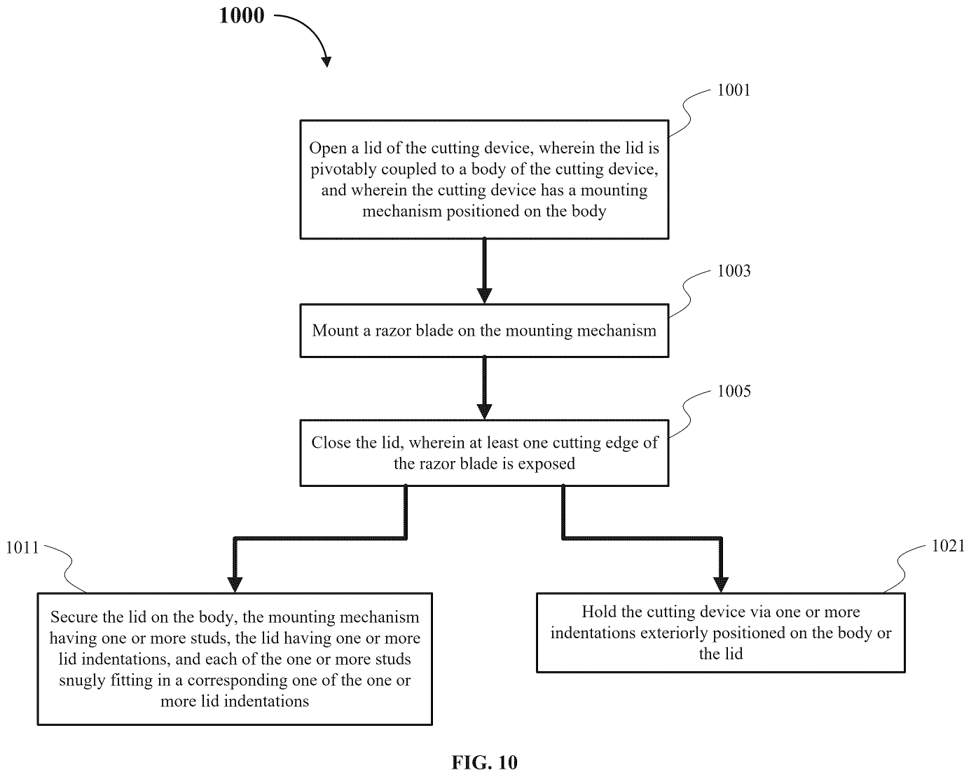

FIG. 10 illustrates a method 1000 of providing a cutting device. Specifically, the method 1000 includes: (i) opening a lid of the cutting device, wherein the lid is pivotably coupled to a body of the cutting device, and wherein the cutting device has a mounting mechanism positioned on the body (Step 1001); (ii) mounting a razor blade on the mounting mechanism (1003); and (iii) closing the lid, wherein at least one cutting edge of the razor blade is exposed, and wherein a spring is coupled between the lid and the body (1005). In some implementations, the lid includes a first arm and a second arm. Both the first arm and the second arm are positioned on opposite sides of the lid. Additionally, each of the first arm and the second arm has one or more tabs that are designed to help a user to open the lid to, e.g., change the razor blade. The spring is designed to tightly hold the lid to snap the lid shut onto the body. Moreover, the lid conceals or encloses other edges including at least one other cutting edge of the razor blade to prevent the user from cuts during cutting operation. When the lid is closed, a lid front of the lid is aligned with a front of the body. The lid front and the front of the body define a concave portion to allow the at least one cutting edge of the razor blade to be exposed for cutting.

As shown in FIG. 10, the method 1000 further includes securing the lid on the body. The mounting mechanism has one or more studs. The lid has one or more lid indentations, and each of the one or more studs snugly fits in a corresponding one of the one or more lid indentations (Step 1011). In Step 1011, the method 1000 allows the user to securely install and/or change the razor blade. Specifically, the method 1000 provides the one or more studs on the mounting mechanism. The one or more studs snugly fit in corresponding holes of the razor blade and also the corresponding lid indentations on the lid. With further help from the spring, the razor blade is securely mounted on the cutting device and being held tightly during cutting operations for the user to conduct precision cutting without getting injured.

The method 1000 further includes holding the cutting device via one or more indentations exteriorly positioned on the body or the lid (Step 1021), as shown in FIG. 10. The one or more indentations are designed to provide tight and convenient grip of the cutting device to the user to facilitate efficient and precise cutting without the risk of finger cuts and/or skin scratches.

While the principles of the disclosure have been described herein, it is to be understood by those skilled in the art that this description is made only by way of example and not as a limitation as to the scope of the invention. Other implementations are contemplated within the scope of the present invention in addition to the exemplary implementations shown and described herein. Modifications and substitutions by one of ordinary skill in the art are considered to be within the scope of the present disclosure, which is not to be limited except by the following claims.

What is claimed is:

1. A cutting device comprising:
a body having a mounting mechanism, wherein a razor blade is removably attached to the mounting mechanism;
a lid, the lid pivotably coupled to the body, wherein the lid partially covers the razor blade and at least one cutting edge of the razor blade is exposed; and
a spring, the spring coupled between the body and the lid.

2. The cutting device of claim 1, further comprising:
one or more indentation, wherein the one or more indentation are positioned on an exterior surface of the body.

3. The cutting device of claim 1, wherein the mounting mechanism includes one or more studs.

4. The cutting device of claim 3, wherein the one or more studs has a shape of a cross.

5. The cutting device of claim 3, wherein the one or more studs include a plurality of studs, wherein the plurality of studs distributes across a longitudinal side of the body, and wherein each of the plurality of studs is configured to align with a corresponding one of a plurality of mounting holes of the razor blade.

6. The cutting device of claim 3, wherein the lid includes one or more lid indentations, and wherein the one or more lid indentations are positioned on an interior lid surface of the lid.

7. The cutting device of claim 6, wherein each of the one or more studs is configured to align with a corresponding one of the one or more lid indentations and snugly fit therein.

8. The cutting device of claim 1, wherein the body further includes a front, a back, a top, and a bottom, wherein the top is positioned on the body opposite the bottom, the top having a front portion and a back portion, the front portion being positioned adjacent the front, and wherein the mounting mechanism is positioned on the front portion of the top.

9. The cutting device of claim 8, wherein the back portion of the top is positioned adjacent the back of the body, wherein the lid covers the front portion of the top, and wherein an exterior top surface of the back portion is flush with an exterior lid surface.

10. The cutting device of claim 9, further comprising:
a first indentation positioned across the exterior top surface of the back portion and the exterior lid surface; and
a second indentation positioned on an exterior bottom surface of the bottom.

11. The cutting device of claim 8, wherein the front portion has one or more curved sides.

12. The cutting device of claim 8, wherein the lid has a lid front, the lid front being aligned with the front of the body to form a concave portion, the at least one cutting edge of the razor blade extending across the concave portion.

13. The cutting device of claim 12, wherein the lid includes one or more tabs, the one or more tabs being externally positioned on the lid adjacent to the lid front.

14. The cutting device of claim 8, wherein the body further includes a first side and a second side, the second side positioned opposite the first side, wherein the back portion and the bottom define a cavity, the cavity being positioned adjacent to the first side, and wherein the cavity has a first interior surface and a second interior surface.

15. The cutting device of claim 14, wherein the spring is distally coupled to the lid, and wherein the spring is attached to the first interior surface of the cavity.

16. The cutting device of claim 14, wherein the lid has a first arm and a second arm, the first arm being coupled to the second interior surface of the cavity, and the second arm being coupled to the second side of the body.

17. A cutting device comprising:
a razor blade having at least one cutting edge;
a body having a mounting mechanism, the razor blade removably attached to the mounting mechanism;
a lid pivotably coupled to the body, the lid partially covering the razor blade and the at least one cutting edge of the razor blade is exposed;
a spring coupled between the body and the lid; and
one or more indentations being positioned on an exterior surface of the body.

18. A method of providing a cutting device, the method comprising:
opening a lid of the cutting device, wherein the lid is pivotably coupled to a body of the cutting device, and wherein the cutting device has a mounting mechanism positioned on the body;
mounting a razor blade on the mounting mechanism; and
closing the lid, wherein at least one cutting edge of the razor blade is exposed, and wherein a spring is coupled between the lid and the body.

19. The method of claim 18, further comprising:
securing the lid on the body, the mounting mechanism having one or more studs, the lid having one or more lid indentations, and each of the one or more studs snugly fitting in a corresponding one of the one or more lid indentations.

20. The method of claim 18, further comprising:
holding the cutting device via one or more indentations exteriorly positioned on the body or the lid.
